(19) United States
(12) Patent Application Publication
(10) Pub. No.: US 2005/0171685 A1
(43) Pub. Date: Aug. 4, 2005

(54) Navigation apparatus, navigation system, and navigation method

(76) Inventors: Terry Leung, La Palma, CA (US); Ricardo Sanchez III, La Puente, CA (US)

Correspondence Address: LORUSSO & LOUD, 3137 Mount Vernon Avenue, Alexandria, VA, 22305, US

(21) Appl. No.: 10/768,183

(22) Filed: Feb. 2, 2004

(51) Int. Cl. G01C 21/26

(52) U.S. Cl. 701/200; 340/995.1

(57) ABSTRACT

In a navigation apparatus, voice input information comprised of a sentence or a plurality of words are divided into respective words and then one or more predetermined words are extracted from the plurality of words, and word-based POI information related to each of the predetermined words is retrieved. Next, one or more phrases each of which is constituted from two or more words contained in the predetermined words are created, and then phrase-based POI information related to each of the created phrases is retrieved. The retrieved phrase-based and word-based POI information are displayed on a display in a selectable manner, and then map information to a destination based on the selected POI information is displayed on the screen.

### BACKGROUND OF THE INVENTION

1. Field of the Invention

The present invention is related to a navigation apparatus, a navigation system, and a navigation method.

2. Description of the Prior Art

A navigation system is a system which is installed in an automobile to provide information related to a travel route from a current position to a destination, for example. An example of a prior art navigation system is disclosed in Japanese Laid-Open Patent Publication No. HEI 9-113299. This prior art navigation system is equipped with a route setting means which sets a specific position on a map displayed by display means as a destination based on control data created by control means based on voice commands recognized by a voice processing section, and sets routes to such destination.

In this navigation system, in the case where information related to travel routes is acquired, when a user inputs information about the destination such as the name or address of a store, shop or facility (the name of the destination) by voice, related POI (point of interest) information based on the user's request is retrieved from a lot of POI information. Next, desired POI information is selected from the retrieved POI information group in accordance with the user's request, and a destination is set based on this POI information. Then, travel routes from the current position to the destination (e.g., map information to or in the vicinity of the destination) are displayed on a display installed in the automobile, and in this way, the user is guided (navigated) to the destination.

Incidentally, in the navigation systems developed in recent years, the POI information is linked to Web information, and this makes it possible to use an extremely large amount of POI information. Further, because the Web information can be updated at all times, the amount of POI information will have a tendency to steadily increase in the future in accordance with the accumulation of new information.

However, in the prior art navigation systems described above, a destination can be set only in the case where the words inputted by the user perfectly match the stored data of the name of the destination, and retrieval is not possible if the memory of the name of the destination is ambiguous or vague. For this reason, even in systems which are capable of using a large amount of POI information from Web information, if the name of the destination is not accurately known, there is the problem that such information can not be adequately utilized.

### SUMMARY OF THE INVENTION

In view of the problems of the prior art described above, it is an object of the present invention to provide a navigation apparatus, a navigation system and a navigation method which make it possible to efficiently retrieve POI information.

In order to achieve the object, the present invention is directed a navigation apparatus. The navigation apparatus comprises word extracting means which divides input information comprised of a sentence or a plurality of words into respective words and then extracts one or more predetermined words from the plurality of words;
word-based POI information retrieving means for retrieving POI information related to each of the predetermined words extracted by the word extracting means;
selecting means which displays one or more POI information retrieved by the word-based POI information retrieving means on a display in a selectable manner; and
display means which displays map information to a destination based on POI information selected by the selecting means.

According to the navigation apparatus of the present invention described above, the input information comprised of a sentence or a plurality of words are divided into the respective words and then a predetermined words are extracted, so that POI information is retrieved based on the extracted words. Therefore, a desired destination can be searched even in the case where the user does not remember the name of the destination accurately or the user merely hopes to go to any desired place or store without having detailed information thereof, so that the burden of inputting the information can be reduced. Namely, according to the present invention, it is possible to find a desired destination based on voice input such as some words that are hit upon or natural conversation even in the case where the accurate name of the destination is not known, and a navigation to such a destination can be carried out.

In the present invention, it is preferred that the navigation apparatus further comprises phrase creating means for creating one or more phrases each of which is constituted from two or more words contained in the predetermined words, and phrase-based POI information retrieving means for retrieving POI information related to each of the one or more phrases created by the phrase creating means, wherein the selecting means displays the POI information retrieved by the phrase-based POI information retrieving means and the word-based POI information retrieving means on the display in a selectable manner.

According to this structure, the phrase-based are created based on two or more of the extracted words in addition to the words and the retrieval of the POI information is carried out based on the extracted words and the created phrases, accuracy of the retrieval for POI information can be improved.

Further, in the present invention, it is preferred that the predetermined words include words which are contained in the sentence or the plurality of words and which have any meaning or relevancy with reference to any POI information. This makes it possible to omit to retrieve words irrelevant to the POI information, thus enabling to simplify the system.

Further, in the present invention, it is also preferred that POI ID is assigned to each of the POI information, and each of the predetermined words and phrases is associated with its POI ID.

Further, it is also referred that the navigation apparatus further comprises means for acquiring POI ID associated with each of the predetermined words and prepared phrases when the POI information related to the words and phrases are retrieved, and means for calculating acquisition frequency of the POI ID for each of the words and phrases, in which the selecting means displays the POI information based on the calculating result of the acquisition frequency of each POI ID. According to this structure, since acquisition frequency is considered for each POI ID, hit ratio for desired POI information can be increased.

Furthermore, it is also preferred that each POI ID is assigned with a weight based on the significance of the associated word or phrase, wherein the calculating result of the acquisition frequency of the POI ID is created taking the weight of each POI ID into account. This also makes it possible to increase hit ratio for desired POI information.

Further, in the present invention, it is preferred that the input information is inputted by means of audio input.

Another aspect of the present invention is directed to a navigation system which includes an input device for inputting input information comprised of a sentence or a plurality of words, a navigation apparatus which provides POI information based on the input information and provides a traveling route to a selected destination, and a display for displaying map information relating to the traveling route, wherein the navigation apparatus comprises: word extracting means which divides the input information into respective words and then extracts one or more predetermined words from the plurality of words; word-based POI information retrieving means for retrieving POI information related to each of the predetermined words extracted by the word extracting means; selecting means which displays the POI information retrieved by the word-based POI information retrieving means on a display in a selectable manner; and display means which displays map information to a destination based on POI information selected by the selecting means.

Further, yet another aspect of the present invention is directed to a navigation method which comprises the steps of: dividing input information comprised of a sentence or a plurality of words into respective words and then extracting one or more predetermined words from the plurality of words; retrieving word-based POI information related to each of the predetermined words; displaying the retrieved word-based POI information on a display in a selectable manner; and displaying map information to a destination based on the selected POI information.

These and other objects, structures and results of the present invention will be apparent more clearly when the following detailed description of the preferred embodiments is considered taken in conjunction with the accompanying drawings.

### DETAILED DESCRIPTION OF THE PREFERRED EMBODIMENTS

A detailed description of the preferred embodiments of the present invention is given below with reference to the drawings. Further, it is of course understood that these embodiments in now way limit the present invention.

System Structure

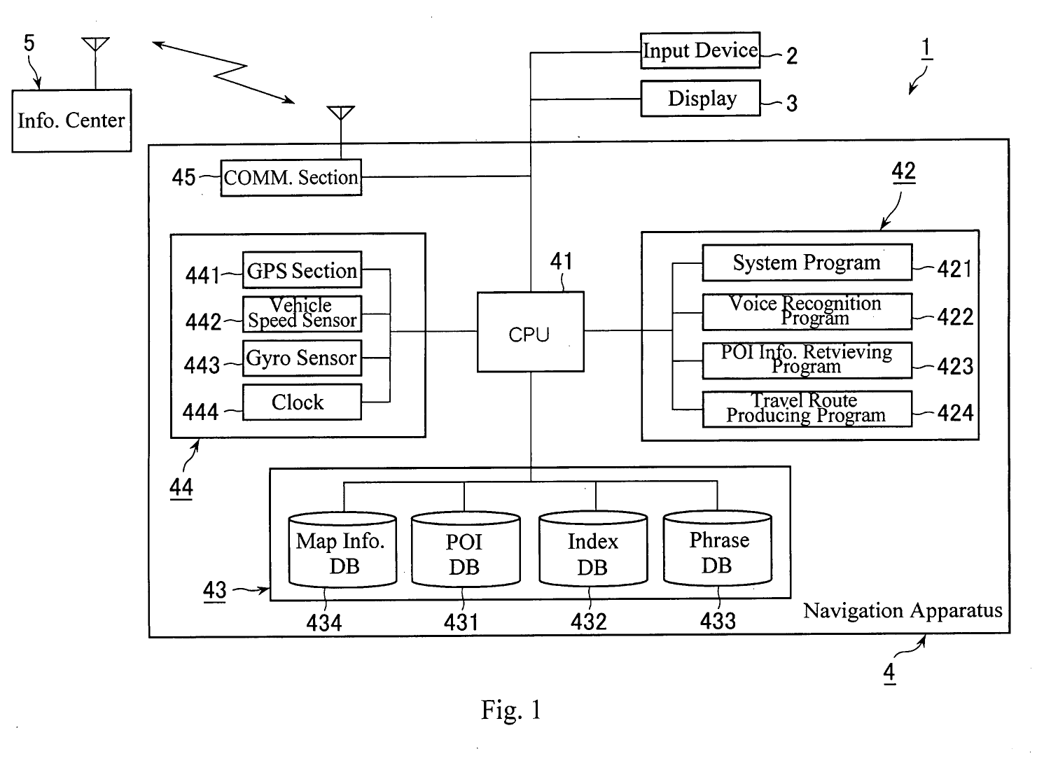

FIG. 1 is a schematic block diagram showing an overall structure of a navigation system according to the present invention. This navigation system 1 is generally constructed from an input apparatus 2, a display 3, and a navigation apparatus 4.

In this navigation system 1, the navigation apparatus 4 has a lot of POI (Point of Interest) information such as store or shop information and facility information, and this POI information is retrieved based on the input information from a user. Then, a destination is set when the user selects a desired item from the retrieved POI information, and map information to or in the vicinity of such destination is created and displayed on the display 3.

Further, in the navigation system 1, the navigation apparatus 4 carries out wireless communication with an outside information center 5, and this makes it possible to acquire detailed POI information (Web information) from the information center 5.

In this navigation system 1, the retrieval of POI information is possible using the conversation or listed words of a user as input information, and this has the benefit of making it possible to retrieve POI information easily and efficiently. Further, in this embodiment, an example is described for the case where the navigation system 1 is mounted in a vehicle. However, the application of the navigation system 1 is not limited thereto.

The input apparatus 2 is an apparatus which allows a user to input the required information (hereafter referred to as “input information”) for acquiring desired POI information. Examples of such an input apparatus 2 include a keyboard, a mouse, a remote control, a directional microphone for voice input or the like. This input apparatus 2 is connected to the navigation apparatus 4, and is arranged near the driver's seat of the vehicle, for example, to make it easy for the user to operate. Further, the input apparatus 4 in the present invention uses a voice input system which is equipped with a microphone (not shown in the drawings), for example. Namely, the input apparatus 2 picks up the user's voice as input information which is then sent to the navigation apparatus 4 in the form of analog signals. The input information is converted to digital signals by an A/D converting portion (not shown in the drawings) of the navigation apparatus 4, and then after being recognized by a voice recognition program 422 of the navigation apparatus 4 described later, this information is used to retrieve POI information.

The display 3 is a display apparatus which displays the retrieval results of the POI information and the map information (travel routes) to or in the vicinity of the destination, and it is constructed from a liquid crystal display device or a CRT display device, for example. Further, this display 3 is connected to the navigation apparatus 4, and is arranged near the driver's seat of the vehicle, for example, to make it easy for the user to see. Further, by combining the display 3 and the input apparatus 2, it is possible to construct a touch panel system.

The navigation apparatus 4 is a functional part for retrieving mainly POI information and map information to the destination, and forms the main part of the navigation system 1. The navigation apparatus 4 is equipped with a CPU 41, a memory 42, a data base 43, a GPS portion 44, and a communication section 45. These structures are described below.

The CPU 41 is a central processing unit which controls the navigation apparatus 4, and is connected via a system bus to the memory 42, the data base 43, the GPS section 44 and the communication section 45, respectively.

The memory 42 is a memory device which forms the main memory space used by the CPU 41. The memory 42 stores a system program 421, a voice recognition program 422, a POI information retrieval program 423, a vehicle position detection program 424, and a travel route producing program 425. These programs 421˜425 are read out and implemented successively by the CPU 41 at the time the navigation system is operated.

The system program 421 is a program which controls the CPU 41. The voice recognition program 422 is a program for recognizing voice signals inputted via the input apparatus 2 as input information from the user. The input information is converted to text information by this voice recognition program 422, and used for retrieving POI information.

Further, the POI information retrieving program 423 includes the following functions: (1) a function which divides the input information to word levels (respective words), (2) a function which extracts prescribed words from the divided input information (the divided words), (3) a function which acquires POI ID related to the extracted words, (4) a function which creates prescribed phrases that include the extracted words, (5) a function which acquires POI ID related to the created phrases, (6) a function which creates a tabulated list of the acquired POI ID, and (7) a function which retrieves POI information based on the tabulated list. These functions (that is, these means or programs) are described in detail later. Further, the POI ID means the ID (Identification) of the POI information stored in a POI data base 431. POI ID is assigned to each POI information.

Further, The vehicle position detection program 424 is a program which detects the position of the vehicle based on measurement information from the GPS section 44 described later, and operates together with the GPS section 44 to form a GPS (Global Positioning System).

Further, the travel route producing program 425 is a program which retrieves and produces optimum travel routes from the current position to the destination based on current vehicle position information detected by the vehicle position detection program 424 and destination information selected via the POI information creating program 423.

The data base 43 forms an auxiliary memory space used by the CPU 21, and is constructed from a hard disk, a compact disc, a digital video disc or the like. The data base 43 stores the POI data base 431, an index data base 432, a phrase data base 433, and a map information data base 434. In these data bases, predetermined information are stored in advance.

The POI data base 431 is formed from many files related to the POI information. The POI information is information related to the name, the address, the category and the like of the facility or store (shop). POI ID is assigned to each POI information, and the POI information is retrievably stored in a listed state together with the POI ID.

Further, the index data base 432 is formed from many word files related to the POI information. These word files are related to words (keywords) assumed as the input information from the user, and are retrievably stored in a listed state together with the associated POI ID and weight index.

Further, the phrase data base 433 is formed from many phrase files related to the POI information. These phrase files are related to phrases (a plurality of connected keywords) assumed as the input information from the user, and are retrievably stored in a listed state together with the associated POI ID and weight index. In this regard, it is to be noted that a higher weight is assigned to each of the phrases as compared with each of the words (described later in more detail).

The data base 43 constructed as described above does not have to be provided in the navigation apparatus 4, and may be provided in the information center 5. In this case, such data base is used by communications via the communication section 45 described later.

Further, the map information data base 434 is a data base formed from a plurality of map information. This plurality of map information is used for producing map information of the destination related to the retrieved POI information.

The GPS section 44 is a functional part which outputs the current position data of the vehicle in which the navigation apparatus 4 is mounted using longitude and latitude. The GPS section 44 is equipped with a GPS sensor 441, a vehicle speed sensor 442, a gyro sensor 443, and a clock 444. The GPS sensor 441 is a sensor which measures the absolute position of the vehicle on the earth by receiving signals from a plurality of GPS satellites, and is constructed from a GPS receiver. The vehicle speed sensor 442 and the gyro sensor 443 are sensors which measure the relative position of the vehicle on the earth. The clock 444 is used for measuring the traveling time of the vehicle which is used in the measurement of the relative position of the vehicle. These sensors 442, 443 and the clock 444 are used in autonomous navigation, and the GPS sensor 441 measures the current position in a relative manner when the vehicle is inside a tunnel or the like where it is not possible to receive electromagnetic signals from satellites, and this is also used for correcting measurement errors of the GPS sensor 441.

The communication section 45 is a wireless communication device which transmits and receives data by a wireless communication line with the information center 5, and uses a wireless communication system such as a LAN (Local Area Network), a vehicle telephone, a portable telephone, a PHS (Personal Handyphone System) or the like, for example.

Further, the communication section 45 acquires various data of the data base 43 from the information center, and the data bases are updated with the newest information.

The information center 5 is located outside the navigation apparatus 4 (and the vehicle in which this is mounted), and forms a server/client system together with the navigation apparatus 4 by wireless communication. The information center 5 has Web information which includes more detailed POI information than the POI information held by the navigation apparatus 4, and the navigation apparatus 4 can acquire this detailed POI information (Web information) by wireless communication.

Navigation Method

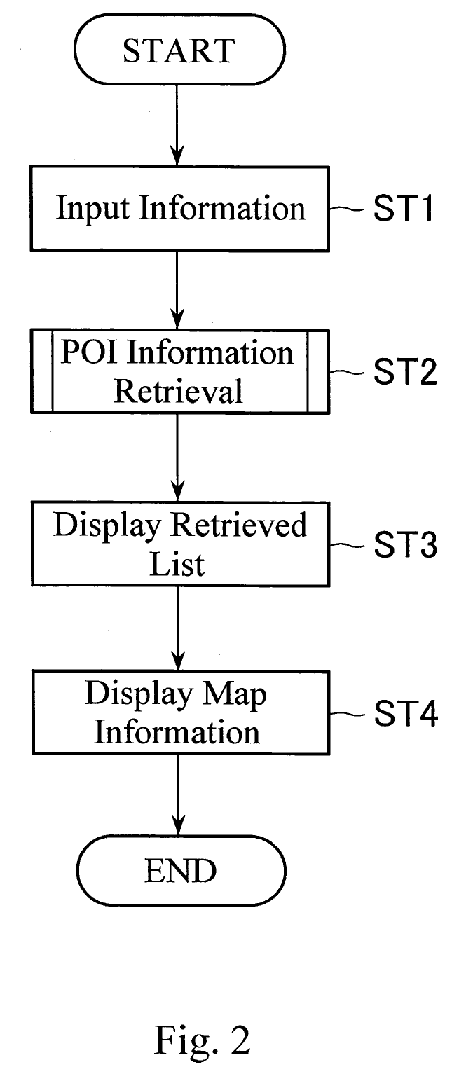

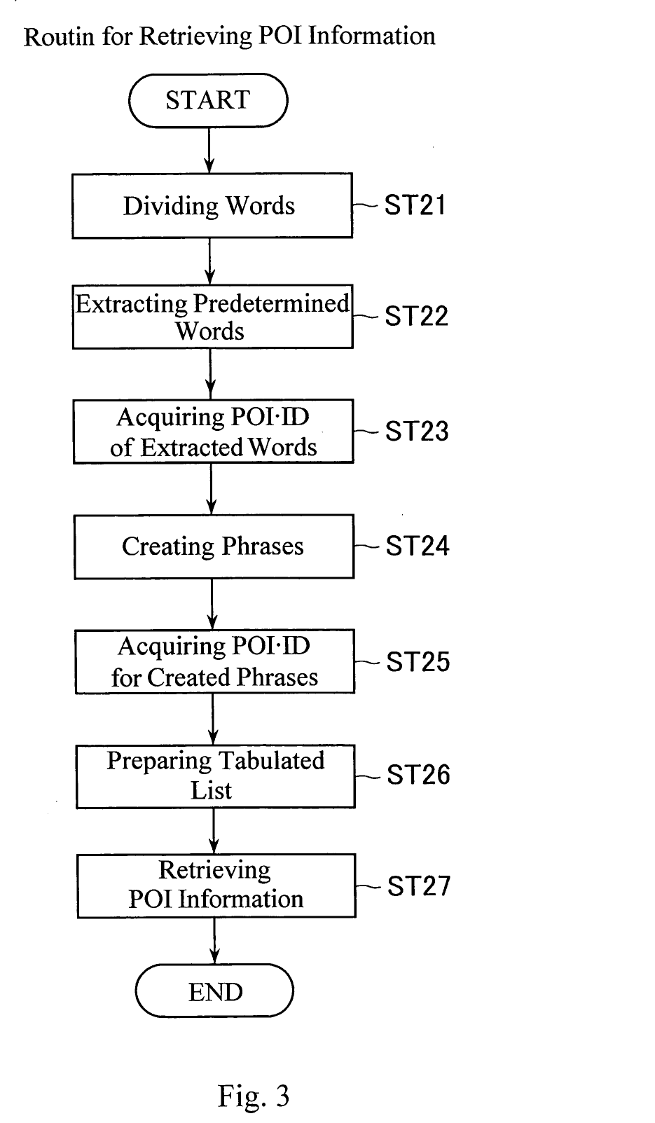

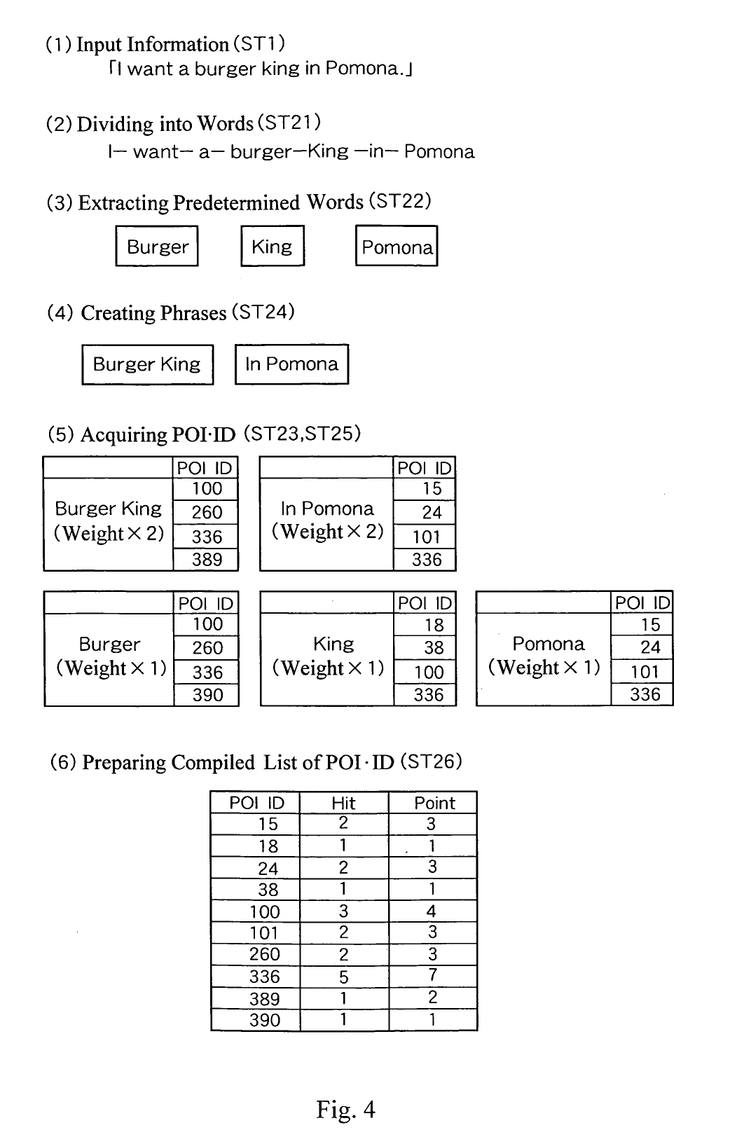

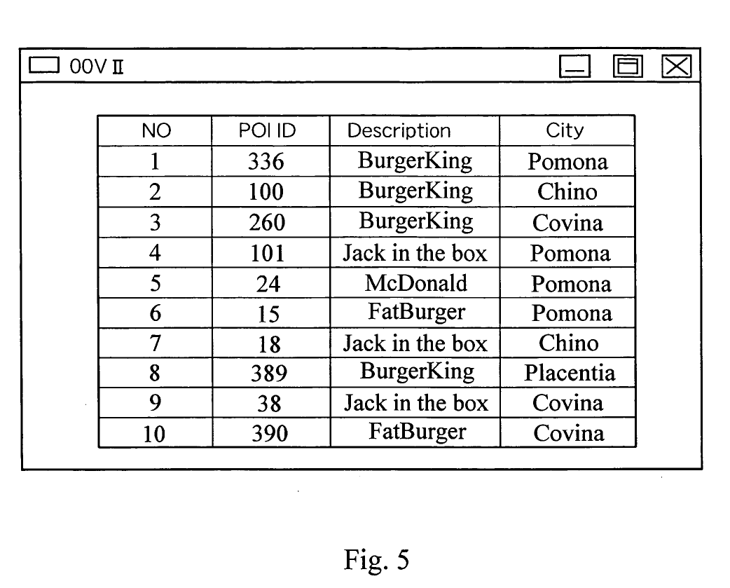

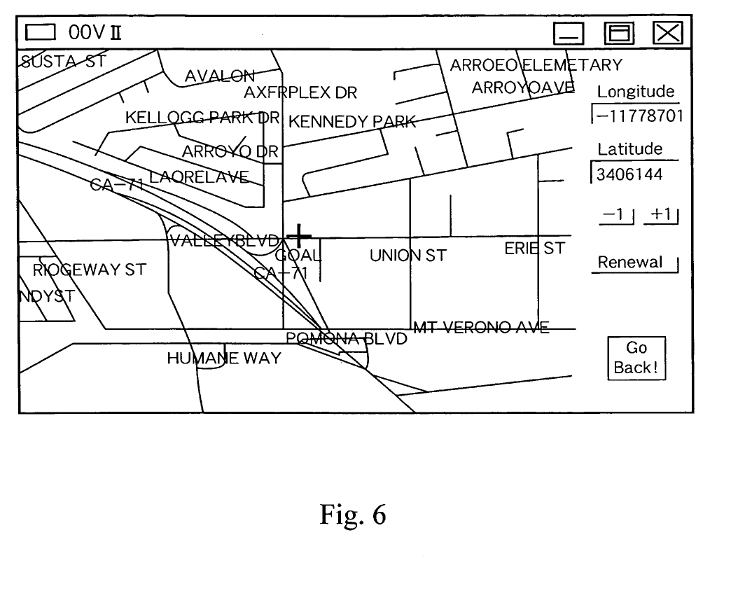

FIG. 2 is a flowchart showing the navigation method of the navigation system shown in FIG. 1. FIG. 3 and FIG. 4 are respectively a flowchart (FIG. 3) showing the POI information retrieval step shown in FIG. 2 and an explanatory drawing (FIG. 4). FIG. 5 is drawing showing an example display of retrieved POI information, and FIG. 6 is a drawing showing an example display of map information related to the POI information selected by the user.

The navigation system 1 according to this embodiment is equipped with the input apparatus 2 which acquires input information comprised of a sentence or a plurality of words, a navigation apparatus 4 which provides POI (Point of Interest) information based on such input information, and provides travel routes to a destination, and a display 3.

The navigation apparatus 4 is equipped with word extracting means which divide the input information comprised of a sentence or a plurality of words into word levels (respective words) and extract prescribed words from these words, word-based POI information retrieving means which retrieve POI (Point of Interest) information related to the prescribed words extracted by the word extracting means, phrase creating means which create phrases that include two or more of the prescribed words, phrase-based POI information retrieving means which retrieve POI information related to the phrases created by the phrase creating means, selecting means which display POI information related to the prescribed words and phrases retrieved by the word-base POI information retrieving means and the phrase-based POI information retrieving means on a display in a selectable manner, and display means which display map information of a prescribed destination based on POI information selected by the selecting means on the display.

Specifically, in the navigation system 1, first, the input apparatus 2 acquires input information from the user and sends this to the navigation apparatus 4 (Information Input Step S1). This input information is information related to the user's request, and is inputted by voice in the input apparatus 2. Further, the input information may be comprised of any listed plurality of words or a conversational sentence such as “I want a Burger King in Pomona”, for example. Further, the input information sent to the navigation apparatus 4 is recognized by the voice recognition program 422 and converted to text information which is then stored in the memory 42.

Next, the navigation apparatus 4 retrieves related POI information from inside the data base 43 based on the input information from the user (POI Information Retrieving Step S2). The retrieval of POI information is carried out by the POI information retrieving program 423 in the memory 42 using a prescribed retrieval routine (S21˜S27) (see FIG. 3 and FIG. 4). This step forms the retrieving means described above. A description of the POI information retrieving routine is given below.

In the POI information retrieving routine, first, the input information is divided into word levels (respective words) which are the structural elements thereof (S21). The divided input information (the divided words) are compared word by word to word files in the index data base 432. Then, in the case where there is a matching word file in the index data base 432, such word is recognized as a significant word (keyword) related to the user's request, and it is extracted and then stored in the memory 42 (S22). These steps form the word extracting means described above.

The index data base 432 is searched for the extracted word, and the associated POI ID is acquired from the index data base 432 and stored in the memory 42 (S23). On the other hand, in the case where there is no matching word file, the POI ID of such word is not acquired. This step forms the word-based POI information retrieving means described above.

Namely, in the case of “I want a Burger King in Pomona” related to the example described above, POI ID is acquired for the words “Burger”, “King” and “Pomona”, and in this case, POI ID is not acquired only for the words “I”, “want”, “a” and “in” which are words that have no meaning for any POI information (see FIG. 4). In other words, the predetermined words include words which are contained in the sentence or the plurality of words and which have any meaning or relevancy with reference to any POI information. This acquisition of POI ID (S23) is carried out for all the extracted words recognized as keywords.

Next, the words having extracted POI ID are grouped together with the words before and after thereof (including prepositions and the like) (see FIG. 4). In this way, a plurality of phrases including significant words are created (S24). This step forms the phrase creating means described above.

The phrase data base 433 is searched for the created phrases, and a comparison with the phrase files in the phrase data base 433 is carried out phrase by phrase. Then, in the case where there is a matching phrase file in the phrase data base 433, such phrase is recognized as a significant phrase (key phrase) related to the user's request, and POI ID associated with this phrase is acquired from the phrase data base 433 and stored in the memory 42 (S25). On the other hand, in the case where there is no matching phrase file, a POI ID associated with such phrase is not acquired. This step forms the phrase-based POI information retrieving means described above.

For example, in the example described above, because there are matching phrases for phrases such as “Burger King” which is a combination indicating one store name and “In Pomona” which is a combination with a preposition indicating the city name and the like, POI ID thereof is acquired for each of them, but because there is no phrase file which matches the three word phrase “Burger King In”, a POI ID is not acquired. As a result, only phrases which have acquired a POI ID (only “Burger King” and “In Pomona” in the above example) are stored in the memory 42 (see FIG. 4).

Next, a tabulated list according to the categories thereof is created for the acquired POI ID, and this tabulated list is stored in the memory 42 (S26). In the creation of this tabulated list, the acquisition frequency of each POI ID (see the “Hit” column in FIG. 4) is counted, and this acquisition frequency is stored in memory in association with the POI ID (see FIG. 4). Further, in the creation of this tabulated list, points which take the weight of each word and each phrase into consideration (see “Point” column in FIG. 4) are calculated, and these points are stored in memory in association with the POI ID. Namely, these points are calculated from the product and the sum of the acquisition frequency and the weight, and as the numerical value thereof becomes higher, the significance of the POI ID becomes higher. In the example described above, a phrase having an acquired POI ID is given twice the weight of a word having an acquired POI ID. In this way, the weight of extracted phrases is set higher than the weight of extracted words. This is because phrases express the intention of the user in more detail than words. From the fact that the POI ID 336 makes a hit in the phrase “Burger King” and the phrase “in Pomona” which have a weight of 2, and a hit in the words “Burger”, “King” and “Pomona” which have a weight of 1, this gives 2′2+3=7 points.

Next, POI information corresponding to each POI ID is retrieved based on the created tabulated list, and a retrieval list (retrieval results) thereof is created and stored in the memory 42 (S27).

Next, the navigation apparatus 4 displays the created retrieval list of the POI information on the display 3 (Retrieval List Display Step S3) in a selectable manner. At this time, the POI information is displayed in an ordered arrangement starting from the highest point POI ID (see FIG. 5). Further, in the case where the POI ID points are the same, the current position of the user is acquired by the GPS section 44, and the POI information closest to the current position is given a higher rank. Then, the user can set the destination for which guidance is desired by selecting any POI information from the displayed retrieval list. This function forms the selecting means described above.

On the display 3, because the POI information close to the intention of the user is displayed at a higher rank, there is the advantage that user benefit related to POI information retrieval is improved. Further, in the selecting of the POI information and the setting of the destination, a voice input system which uses sound collecting means may be utilized, or a touch panel system which uses the display 3 may be utilized.

Next, the navigation apparatus 4 displays map information to or in the vicinity of the destination selected by the user on the display 3 (Map Information Display Step S4). This function forms the display means described above. The navigation apparatus 4 shows the user travel routes to the destination by displaying related map information.

Further, the navigation apparatus 4 may (1) display travel routes from the current position to the destination on the display 3, and (2) guide the user by announcing the travel routes with a voice output device (omitted from the drawings). In this way, there is the advantage that it is possible for the user to understand the travel routes in detail. In these structures, it is possible to use the structure of an existing car navigation system.

Further, the navigation apparatus 4 may be given a structure which acquires detailed POI information from an information center based on the user's request, and displays such POI information on the display 3. Namely, the navigation apparatus 4 accesses the information center 5 via the communication section 45, and downloads detailed POI information as Web information from the information center 5, and then desired information selected by the user is displayed on the display 3. In this way, there is the advantage that this makes it possible to provide the user with more detailed POI information.

Advantages

In this navigation system 1, because a conversational sentence or any listed plurality of words is used as input information, compared with prior art navigation systems, there is the advantage that this makes it possible to reduce the burden on the user related to the retrieval of POI information. Namely, in order to retrieve POI information in prior art navigation systems, the user needs to input required input information one by one accurately in accordance with a prescribed process, but in the navigation system 1, there is no need for such steps. Therefore, in the present invention, there is the advantage that it is possible to easily retrieve POI information by a conversation or a list of words of the user.

Further, because the user can use any plurality of words having any grammar as input information, compared with prior art navigation systems, the user can input required input information by more free expressions. In this way, because the burden on the user is reduced at the time the input information is inputted, POI information can be retrieved more easily.

Further, when POI information is acquired in prior art navigation systems, the name, address, telephone number, assigned category and the like of the facility or store needs to be inputted accurately in accordance with a prescribed input method. However, because the case where the user accurately remembers such input information is rare, there is the problem that the POI information can not be retrieved in the case where the user's memory is vague. In contrast with this, in the navigation system 1, because a conversation or a list of words of the user can be used as input information, there is the advantage that it is possible to efficiently retrieve required information without inputting all the keywords required for retrieval. Further, in such structure, because the user can use expressions based on ideas as input information, there is the advantage that it is possible to retrieve POI information outside the recognized range of the user.

Further, in the navigation system 1, as the keywords and key phrases included in the input information increases, the extracted POI ID increases, and a large amount of POI information is retrieved. Then, the amount of input information can be freely adjusted in accordance with the amount of conversation and the amount of listed words of the user. Accordingly, there is the advantage that the user can freely adjust the retrieval range of POI information by adjusting the amount of input information. Further, in such structure, the retrieved POI information is displayed on the display 3 in a listed order arrangement starting from the highest acquisition frequency of the POI ID. Accordingly, because the POI information is displayed on the display 3 in an easily usable state regardless of the width of the retrieval range, there is the advantage that user benefit related to POI information retrieval is improved.

Further, in the navigation system 1, the input information is divided into the main words (keywords) and phrases (key phrases) which include two or more of these words, and because POI information is retrieved based on these keywords and key phrases, compared with the prior art navigation systems, there is the advantage that it is possible to retrieve POI information which is closer (i.e., has a high hit ratio) to the intention of the user.

Further, in the navigation system 1, a tabulated list in which the POI ID acquisition frequency is tabulated is created, and because the retrieval results of the POI information are displayed on the display 3 based on the tabulation list, there is the advantage that it is possible to retrieve POI information which is closer to the intention of the user. Further, because the weight of each keyword and each key phrase is added to this list, there is the advantage that it is possible to retrieve POI information which is closer to the intention of the user.

Further, in the navigation apparatus 1, the input apparatus 2 uses a voice input system as described above. This is preferred in the case where the navigation system 1 is mounted in a vehicle, for example, because it makes it possible for the user who is the driver to easily input the input information while driving the vehicle. However, the navigation system 1 is not limited to this, and the input apparatus 2 may use a touch panel system integrally formed with the display 3, a remote control system which inputs the input information via a remote controller, a gesture recognition system which recognizes gestures of the user as input information, or any other input system.

Further, in the navigation system 1, the input apparatus 2 and the display 3 are constructed separately with respect to the navigation apparatus 4, and are connected to the navigation apparatus 4 via a wired or wireless arrangement. This is preferred because the input apparatus 2 and the display 3 are sold separately in the distribution process of products, and it is possible to connect any input apparatus 2 and display 3 to the navigation apparatus 4 in accordance with the optional selection of the user and the specification of the vehicle. However, the navigation system 1 is not limited to this, and the input apparatus 2 and the display 3 may be integrally constructed with respect to the navigation apparatus 4.

Finally, it is to be understood that many changes and additions may be made to the embodiments described above without departing from the scope and spirit of the invention as defined in the following claims.

1. A navigation apparatus, comprising:
word extracting means which divides input information comprised of a sentence or a plurality of words into respective words and then extracts one or more predetermined words from the plurality of words;
word-based POI information retrieving means for retrieving POI information related to each of the predetermined words extracted by the word extracting means;
selecting means which displays one or more POI information retrieved by the word-based POI information retrieving means on a display in a selectable manner; and
display means which displays map information to a destination based on POI information selected by the selecting means.

2. The navigation apparatus as claimed in claim 1, further comprising phrase creating means for creating one or more phrases each of which is constituted from two or more words contained in the predetermined words, and phrase-based POI information retrieving means for retrieving POI information related to each of the one or more phrases created by the phrase creating means, wherein the selecting means displays the POI information retrieved by the phrase-based POI information retrieving means and the word-based POI information retrieving means on the display in a selectable manner.

3. The navigation apparatus as claimed in claim 1, wherein the predetermined words include words which are contained in the sentence or the plurality of words and which have any meaning or relevancy with reference to any POI information.

4. The navigation apparatus as claimed in claim 2, wherein POI ID is assigned to each of the POI information, and each of the predetermined words and phrases is associated with its POI ID.

5. The navigation apparatus as claimed in claim 4, further comprising means for acquiring POI ID associated with each of the predetermined words and prepared phrases when the POI information related to the words and phrases are retrieved, and means for calculating acquisition frequency of the POI ID for each of the words and phrases, in which the selecting means displays the POI information based on the calculating result of the acquisition frequency of each POI ID.

6. The navigation apparatus as claimed in claim 5, where each POI ID is assigned with a weight based on the significance of the associated word or phrase, wherein the calculating result of the acquisition frequency of the POI ID is created taking the weight of each POI ID into account.

7. The navigation apparatus as claimed in claim 1, wherein the input information is inputted by means of audio input.

8. A navigation system which includes an input device for inputting input information comprised of a sentence or a plurality of words, a navigation apparatus which provides POI information based on the input information and provides a traveling route to a selected destination, and a display for displaying map information relating to the traveling route, wherein the navigation apparatus comprises:
word extracting means which divides the input information into respective words and then extracts one or more predetermined words from the plurality of words;
word-based POI information retrieving means for retrieving POI information related to each of the predetermined words extracted by the word extracting means;
selecting means which displays the POI information retrieved by the word-based POI information retrieving means on a display in a selectable manner; and
display means which displays map information to a destination based on POI information selected by the selecting means.

9. The navigation system as claimed in claim 1, wherein the navigation apparatus further comprises phrase creating means for creating one or more phrases each of which is constituted from two or more words contained in the predetermined words, and phrase-based POI information retrieving means for retrieving POI information related to each of the phrases created by the phrase creating means, wherein the selecting means displays one or more POI information retrieved by the phrase-based POI information retrieving means and the word-based POI information retrieving means on the display in a selectable manner.

10. The navigation system as claimed in claim 8, wherein the predetermined words include words which are contained in the sentence or the plurality of words and which have any meaning or relevancy with reference to any POI information.

11. The navigation system as claimed in claim 9, wherein POI ID is assigned to each of the POI information, and each of the predetermined words and phrases is associated with its POI ID.

12. The navigation system as claimed in claim 11, wherein the navigation apparatus further comprises means for acquiring POI ID associated with each of the extracted words and the created phrases when the POI information related to the words and phrases are retrieved, and means for calculating acquisition frequency of the POI ID for each of the words and phrases, in which the selecting means displays the POI information based on the calculating result of the acquisition frequency of each POI ID.

13. The navigation system as claimed in claim 12, where each POI ID is assigned with a predetermined weight based on the significance of the associated word or phrase, wherein the calculating result of the acquisition frequency of the POI ID is prepared taking the weight of each POI ID into account.

14. The navigation system as claimed in claim 8, wherein the input information is inputted by means of audio input.

15. A navigation method which comprises the steps of:
dividing input information comprised of a sentence or a plurality of words into respective words and then extracting one or more predetermined words from the plurality of words;
retrieving word-based POI information related to each of the predetermined words;
displaying the retrieved word-based POI information on a display in a selectable manner; and
displaying map information to a destination based on the selected POI information.

16. The navigation method as claimed in claim 15, further comprising the steps of: creating one or more phrases each of which is constituted from two or more words contained in the predetermined words, and retrieving phrase-based POI information related to each of the created phrases, wherein the displaying step displays the retrieved phrase-based and word-based POI information on the display in a selectable manner.

17. The navigation method as claimed in claim 15, wherein the predetermined words include words which are contained in the sentence or the plurality of words and which have any meaning or relevancy with reference to any POI information.

18. The navigation method as claimed in claim 16, wherein POI ID is assigned to each of the POI information, and each of the predetermined words and phrases is associated with its POI ID.

19. The navigation method as claimed in claim 18, further comprising the steps of acquiring POI ID associated with each of the predetermined words and the prepared phrases when the word-based POI information and the phrase-based POI information are retrieved, and calculating acquisition frequency of the POI ID for each of the words and phrases, in which the POI information based on the calculating result of the acquisition frequency of the POI ID is displayed on the display.

20. The navigation method as claimed in claim 19, where each POI ID is assigned with a predetermined weight based on the significance of the associated word or phrase, wherein the calculating result of the acquisition frequency of the POI ID is prepared taking the weight of each POI ID into account.

21. The navigation method as claimed in claim 15, wherein the input information is inputted by means of audio input.
